(19) United States
(12) Patent Application Publication
(10) Pub. No.: US 2006/0050376 A1
(43) Pub. Date: Mar. 9, 2006

(54) Robotic microscopy apparatus for high throughput observation of multicellular organisms

(76) Inventors: Edward S. Houston, Danville, CA (US); J. Albert Howard JR., San Jose, CA (US); Peter J. Roy, Toronto (CA); Karl Johanson, Gilbert, AZ (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 11/213,318

(22) Filed: Aug. 25, 2005

Related U.S. Application Data
(60) Provisional application No. 60/607,221, filed on Sep. 2, 2004.
(60) Provisional application No. 60/649,727, filed on Feb. 2, 2005.

(51) Int. Cl. G02B 21/26

(52) U.S. Cl. 359/392; 359/368

(57) ABSTRACT

The present invention relates to a robotic microscopy apparatus that is able to screen, detect, count and image in an automated and high throughput fashion whole multicellular organisms, tissues, individual cells and groups of cells on or embedded within agar, collagen or other defined matrix. To achieve this, the robotic apparatus of the invention images the samples from the top using a microscope with a long working distance. The invention provides robotic systems for plate handling, biological sample immobilization and microscopic examination. The invention also provides for automatic image acquisition, image storage and display, and image analysis.

### CROSS-REFERENCE TO RELATED APPLICATIONS

This application claims priority under 35 U.S.C. § 119(e) to U.S. Provisional Application Ser. No. 60/607,221 filed on Sep. 2, 2004 and to U.S. Provisional Application Ser. No. 60/649,727 filed on Feb. 2, 2005; the disclosures of which are herein incorporated by reference.

### INTRODUCTION

1. Background of the Invention

Discovery and technological advances continues to surround high throughput analyses in academic, biotechnological and pharmaceutical settings. Thus far, high throughput analyses have focused primarily on the use of cells as biological entities or targets for testing.

High throughput experimentation has been made possible with the generation of roboticized apparatuses and chemical reagents including, but hot limited to, chemical libraries derived from combinatorial and medicinal chemistry, and biological reagents derived from genome sequencing efforts (e.g. siRNA).

In addition to cells, model multicellular organisms can serve as the biological samples or targets for testing. Such organisms include, but are not limited to, worms (e.g., Caenorhabditis), flies (e.g., Drosophila), fish (e.g., Zebrafish), frogs (e.g., Xenopus) and rodents (e.g., rats (Rattus) and mice (Mus)). Each of these model organisms have various attributes that are exploited by researchers for their own purposes.

Screening methods with model organisms is extremely labor intensive, with experimental personnel required to inspect each plate or well containing a specimen(s) or organism(s). This clearly limits the throughput of any screening method used with any model organism. With the limitation imposed by these present human-based screening procedures, high-throughput analyses with model organisms are not practical at the economical or workforce level.

Apparatuses to quantify various characteristics of cells are well known in the art. Inverted microscope configurations and computer control for automatic focusing and microscope stage positioning have been used for imaging of biological samples. Examples include such apparatuses as the Cellomics Arrayscan, Molecular Devices FLIPR, Acumen Bioscience Explorer, and Amersham Bioscience IN Cell Analyzer 1000, which quantify a color or fluorescent metric for cell behavior or activity (e.g. proliferation, apoptosis, pH changes). These apparatuses have revolutionized the biotechnology and pharmaceutical industries by high throughput screening of millions of potential drugs.

However, each of the currently available apparatuses has limitations. These limitations singly or in combination include detector, sample, sample holder (e.g., plate versus slide) and most importantly the working distance between the apparatus and sample and the ability to view a sample from the upright position rather than an inverted position. The working distance restricts the type of sample that can be analyzed. Currently available apparatuses use what is known as a short working distance (SWD) between the sample and detector or objective of the apparatus. This is due to the fact that the current apparatuses use an inverted approach to viewing or detecting samples. That is, they view or detect samples from below or underneath the sample and sample holder. This short working distance reduces the types of experiments that can be carried out, and the quality of images that can be obtained with the currently available apparatuses when viewing whole organisms.

Additionally, despite these methods and apparatuses, no available apparatus effectively provides for automated imaging of whole organisms. Further, no apparatus known to the applicant is able to do so in a multi-well format or high throughput manner. And still further no apparatus known to the applicant is able to temporarily immobilize whole, live organisms to obtain high resolution images. The present invention satisfies these needs, as well as others, and overcomes deficiencies found in the background references.

References of Interest

Patents of interest include: U.S. Pat. Nos. 6,678,391; 6,573,039; 6,345,115; 6,620,591; 6,246,785; 6,122,396; 6,049,421; 6,005,964; 5,991,028; 5,978,498; 5,861,985; 5,594,235; 4,974,952; 4,958,920; 4,920,053; 4,705,949; 4,000,417; 3,922,532; and 3,811,036; the disclosures of which are incorporated herein by reference.

Publications of interest include: Anal Biochem 2001 June 15;293(2):258-63, Ultramicroscopy 2001, April;87(3): 155-64, Folia Histochem Cytobiol 2001;39(2):75-85, Trends Cell Biol 2001 August;11(8): 329-34, J Microbiol Methods 2000 October;42(2):129-38, J Immunol Methods 1999 November 19;230(1-2):11-8, and Environmental Health Perspective 1999, November; 107(11); and Nature 2001 May; 411: 107-110, the disclosures of which are incorporated herein by reference.

### SUMMARY OF THE INVENTION

The present invention relates to a robotic microscopy apparatus that is able to screen, detect, count and image in an automated and high throughput fashion whole multicellular organisms, tissues, individual cells and groups of cells on or embedded within agar, collagen or other defined matrix. The invention comprises a robotic system for plate handling with removable towers and a stereo-optic system with motorized and encoded zoom magnification changer. The system has a motorized encoded XY stage with automated centering system, motorized encoded Z focusing column, motorized filter wheels for excitation and emission wave lengths and motorized intensity control, automated computer controlled gas dispensing, and motorized objective turret. A motorized device moves a fluorescing substrate into the light path below the sample to provide a bright field illumination source when illuminated from an epifluorescent source. A barcode reader detects which trays are loaded and reads which protocol to run.

The invention provides a method for imaging one or more optical characteristics of a biological specimen which includes placing a plate containing a biological specimen onto the observation stage under the objective of a microscope with a long working distance using a robotic plate handling system, locating the biological specimen in the plate, focusing the microscope to observe said one or more optical characteristics of the biological specimen and collecting, analyzing, and storing image data of the observed biological specimen wherein each of the steps is automated using integrated hardware and software components. The microscope used in this method may be an autofocusing dissecting microscope with at least one objective mounted on a motorized movement element (or turret). The optical characteristics imaged can be fluorescent emissions, luminescent emissions, chemiluminescent emissions, and/or reflected light.

In these methods, the biological specimen can be a multi-cellular organism, including members of the Genus Caenorhabditis, Drosophila, Danio, or Xenopus, or the Phylum Chordata. The multicellular organism observed can be alive and, if necessary, immobilized by exposing it to an immobilizing compound prior to visualization using an automated immobilization system. The immobilization can be reversible or irreversible depending on the assay. In some assays, the immobilizing compound is CO₂ gas.

In some embodiments, the biological specimen is grown on or in a semi-solid substrate of greater than 5 mm in thickness. The biological specimen may be an embryoid body or a plant.

In some assays, the biological specimen is contacted with a candidate agent. In certain of these embodiments, the agent is contacted to the biological specimen after obtaining a first image and prior to obtaining a second image of the biological specimen.

In certain embodiments, the plate holding the biological specimen contains multiple independent wells. The plate can be housed in a handling unit that contains a plurality of plates and each plate can be identified using a bar code tagging and scanning system.

In some embodiments, locating the biological specimen is achieved using a motor-driven x-y stage on the microscope which automatically aligns the plates and wells thereof with respect to the position of the objectives of the microscope.

Imaging of the biological specimen can be done using a CCD camera for real-time visualization and capturing of images viewed through the microscope either of individual organisms or of the entire well or plate of organisms. The data can be collected, analyzed and stored using software for viewing archived or real time images.

The invention provides an automated microscopy apparatus for imaging at least one optical characteristic of a biological specimen in a plate. The apparatus contains an autofocusing microscope with a long working distance that observes the biological specimen from above; a robotic plate handling system; a CCD camera for real-time visualization and capturing of images viewed through the microscope; and software and hardware to control the microscopy system and store and analyze the images obtained. The apparatus can further contain a motor-driven x-y stage positioned under the objective of the microscope which holds the plate containing the biological specimen to be observed.

The microscopy apparatus contains at least one objective mounted on a motorized movement element (or turret).

The microscopy apparatus may further contain multiple light sources and optical filters for direct bright field illumination, indirect lighting and fluorescent viewing and imaging of the biological specimen.

The microscopy apparatus may also further contain software for processing image data.

The microscopy apparatus may further contain an automated immobilizing compound injection system which in some instances immobilizes the biological specimen using CO₂ gas.

The microscopy apparatus may also contain a robotic plate handling system which holds multiple plates and may have a bar code reader system.

### BRIEF DESCRIPTION OF THE DRAWINGS

FIG. 1 is a view of a preferred embodiment of the apparatus from the left side.

FIG. 2 is a view of a preferred embodiment of the apparatus from the right side.

FIG. 3 is a view of a preferred embodiment of the apparatus from above.

FIG. 4 is a view of a preferred embodiment of the apparatus from the front.

FIG. 5 is a schematic of how the light source and image pass through a common objective

FIG. 6 shows a panel of images taken by the optical assembly of the apparatus of a biological sample.

FIG. 7 details aspects of the immobilization agent delivery device.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

In general, the systems and methods of the invention involve imaging of biological specimens which are provided on a substrate. In this context, “substrate” is meant to describe the material on which the cells, organism or subject entity for imaging are provided (e.g., grown) as well as any constituents of the well provided to maintain the viability of the specimen or to affect its growth, function, or survival. The substrate may comprise a plurality of wells (i.e., at least two), which can be provided in an array format. The substrate may include growth media in the form of a solution, a semi-solid matrix or a solid composition. The substrate may further include compounds, chemicals or other agents that are being tested for their effect on the biological specimen, as in a high throughput drug screen.

A “multi-well plate” or “plate” is a non-limiting example of such a well-containing substrate in which multiple discrete regions are provided, whereby the wells are provided in an array. Another manner of providing discrete regions is presented, for example, in Nature vol. 411: 107-110 noted above where a monolayer of cells is grown over DNA spots, whereby discrete image/analysis areas are provided. A further example is in a DNA or protein array. Substrates can comprise any suitable material, such as plastic, glass, and the like. Plastic is conventionally used for maintenance and/or growth of biological specimens in vitro, and is referred to in the specification as exemplary of substrate materials without limitation.

By “well” it is meant generally a bounded area of a substrate (e.g., defined by a substrate), which may be either discrete (e.g., to provide for an isolated sample) or in communication with one or more other bounded areas (e.g., to provide for fluid communication between one or more samples in a well). For example, biological specimens grown on the substrate are normally contained within a well, which can further provide for containing culture medium for living cells.

A “multi-well plate”, as noted above, is an example of a substrate comprising wells in an array. Multi-well plates that are useful in the invention can be of any of a variety of standard formats (e.g., plates having 2, 4, 6, 24, or 96, wells), but can also be in a non-standard format (e.g., 3, 5, 7, etc. wells).

By “biological specimen” is meant any variety of living entity of interest of which the present invention is intended to observe and image. For example, whole multicellular organisms (e.g., C. elegans and D. menlanogaster), groups of cells of a particular type (e.g., liver cells), clusters of cells derived from a common stem cell (e.g., embryoid bodies), tissue derived from a multicellular organism (e.g., fetal thymus), and any other live entity, including individual cells, are all biological specimens as used herein. Biological specimens in which a response is observed may be referred to herein as “targets”, without any intended limitation as to the type of biological specimens.

By “optical characteristic”, or “imaging characteristic” or “variable” is meant any parameter chosen for viewing and recording data of the subject biological specimen. For example, the expression of fluorescent proteins in cells of a multicellular organism or even in a single cell can be detected when the biological specimen is exposed to light the appropriate wavelength and viewed using the appropriate light filter, as is well known in the art. In some instances, the “optical characteristic” may be negative, meaning that the biological specimen is undetectable using a particular illumination/filter set (e.g., when the system of the present invention is set up to image GFP expression but the subject biological specimen does not express GFP). The “optical characteristic” may also be a characteristic of the observed biological specimen that is independent of the means by which the specimen is illuminated or observed. Such characteristics, which can be user defined, include the number of biological specimens in a field of view or well, the size and/or shape of an individual biological specimen, or the distribution of biological specimens on the substrate.

With regard to the microscope assembly, a “long working distance” means that the distance between the objective and the specimen being visualized (e.g., when the specimen is in focus) is at least about 4 millimeters (4 mm), including at least about 5 mm, at least about 6 mm, or at least about 7 mm or more including at least about 10 mm. Along working distance can be very large, including up to about 200 mm or longer, including up to about 170 mm, about 150 mm, about 130 mm, about 100 mm, or up to about 80 mm. As such, in representative embodiments the working distance of the microscope ranges from about 4 mm to about 200 mm, including from about 4 mm to 170 mm, from about 5 mm to 170 mm, from about 6 mm to 170 mm, etc., and including from about 4 mm to about 15 mm, from about 4 mm to about 25 mm, and from about 4 mm to about 50 mm. In essence, “long working distance” includes working distances that are employed in currently available dissecting and stereoscopic microscopes. In practical use, a long working distance allows for the visualization of specimens from above while the specimen is present in a plate, on a substrate, or in a well of a multiwell plate. In other words, the plate (or substrate) containing the specimen does not interfere with (e.g., contact) the objective when the plate is positioned on the stage and the specimen is in focus.

### DETAILED DESCRIPTION OF THE INVENTION

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The publications (including patents) discussed herein are provided solely for their disclosure prior to the filing date of the present application. Nothing is to be construed as an admission that the present invention is not entitled to antedate such publications by virtue of prior invention. All publications (again, including patents) mentioned herein are incorporated herein by reference to disclose and describe the methods, systems or other subject matter in connection with which the publications are cited.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Embodiments of the robotic microscopy apparatus of the present invention include, but are not limited to, providing the hardware and software to: 1) have sufficient resolution to view tissues and cells within a whole organism, 2) view live organisms and preserve their viability, 3) have a long working distance between biological sample and the objective, 4) identify and quantify biological samples contained in a variety of multiwell plate formats, 5) view and capture images of biological samples placed on or in a substrate (e.g. agar or Matrigel) greater than 1 mm thick, and 6) administer an immobilizing (e.g., anesthetizing) gas or liquid to temporarily immobilize live organisms to enable image capturing.

Certain embodiments of the present invention use a stereo-optic microscope to view and image samples from above rather than from below (e.g., as is done using an inverted microscope assembly). In some of these embodiments, a dissecting microscope, which has increased (or long) working distance between the sample chamber (e.g., multiwell plate) and microscope objective allowing a larger field of view and hence larger biological samples to be viewed, is used for viewing the model organisms. In addition to viewing model organisms, certain embodiments of the invention allow one to view and image cells in a similar manner to currently available apparatuses. In other embodiments, the invention allows for cells placed on various substrates (e.g., Matrigel, agar, and collagen) to be viewed and imaged that would not be possible using current apparatuses because they view, image and detect biological samples from below (inverted). The short working distances associated with currently available apparatuses would preclude them from viewing biological samples through the substrate. Therefore, some embodiments of the invention provide the unique capability of viewing whole organisms while maintaining the attributes and capabilities of currently available apparatuses, thus greatly expanding the capabilities of a researcher using a single apparatus.

In some embodiments of the invention, a computer-controlled apparatus comprised of units and subsystems operates as a complete system to automate image viewing and capturing for the purposes of quantifying and characterizing whole organisms, tissues, cells or a group or groups of cells.

Certain embodiments of the invention feature an automated or robotic microscope system and methods that allows high through-put biological analyses of biological specimens. In some of these embodiments, the invention allows for precise return to and re-imaging of the same plate (or well of a plate) of a living biological specimen(s) that has been imaged earlier. This capability enables experiments and test hypotheses that deal with causality over time intervals which are not possible with conventional microscopy methods.

In certain embodiments, system hardware is configured to allow imaging of live biological specimens grown on plates (e.g., multiwell plates) containing growth media appropriate to maintain the viability of the biological specimen for the duration of the experiment.

In certain embodiments, the invention is implemented by way of hardware, optionally as described below, and computer programming. Programming embodying the features or methodology described herein may be originally loaded into the automated microscope, or the microscope may be preprogrammed to run the same. Such programming, routines and associated hardware constitute various “means” as may be referenced in the claims made hereto. For example, the programmed computer referenced herein comprises a means for directing the action of the various controllers provided. Associated programming can be recorded on computer readable media (i.e., any medium that can be read and accessed by a computer). Such media include, but are not limited to: magnetic storage media, such as floppy discs, hard disc storage medium, and magnetic tape; optical storage media such as CD-ROMs and DVDs; electrical storage media such as RAM, ROM and EPROM; and hybrids of these categories such as magnetic/optical storage media.

Certain embodiments of the invention may include any or all of the following features:

a) an optical microscope assembly;

b) a motorized XYstage for placing a plate or dish onto;

c) a robotic arm and controller for plate-handling;

d) removable plate storage racks and de-lidding station;

e) a lighting subsystem;

f) an imaging capturing subsystem;

g) an anesthetizing gas/liquid delivery subsystem;

h) a data storage subsystem;

i) a system control computer;

j) software run by the system control computer for controlling the apparatus and its subsystems; and

k) a vibration isolation table.

Certain embodiments of the methods of the invention may include any or all of the following steps:

a) robotically handling, moving and de-lidding numerous plates containing biological samples to a microscope stage;

b) temporarily anesthetizing organisms (if necessary);

c) imaging samples within the wells of the plates or dishes using bright field and/or fluorescent illumination with the microscope assembly;

d) capturing images with a digital, cooled camera;

e) converting the optical information into digital data;

f) storing the optical information and digital data;

g) analyzing the optical information and digital data as defined by the user; and

h) transforming and transmitting the stored optical information and digital data to the user.

It is one object of the invention to automate a process that is currently manual and labor intensive.

It is another object of the invention to reduce the cost associated with carrying out biological research by combining unique and currently available means for viewing a wide variety of biological samples into a single apparatus.

It is another object of the invention to provide a means for automated handling of biological samples consisting of whole, live organisms in an environmentally controlled atmosphere.

It is another object of the invention to visualize biological samples using a dissecting or stereo microscope.

It is yet a further object of the invention to provide an automated means to capture, store and analyze optical information obtained from an upright microscope assembly.

It is yet a further object of the invention to provide the ability to view and image the same sample using multiple light sources.

Various embodiments of the system and methods of the invention will now be described in more detail. Such descriptions are followed by Examples providing additional aspects of the invention. Other objects, features and advantages of the present invention will become apparent to those skilled in the art through the description of the embodiments, claims and drawings herein.

Hardware

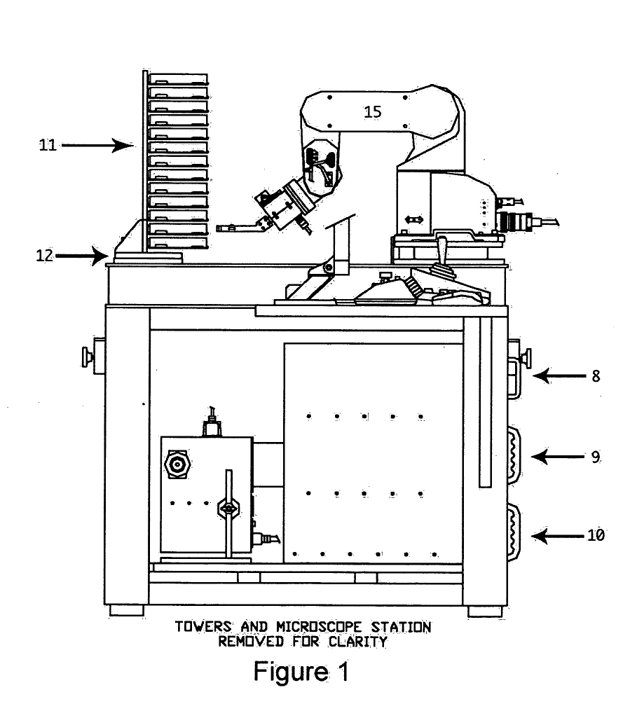

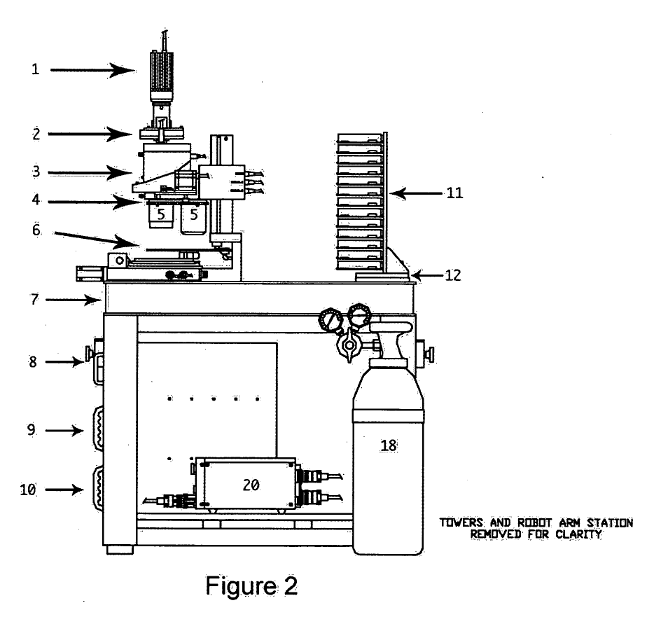

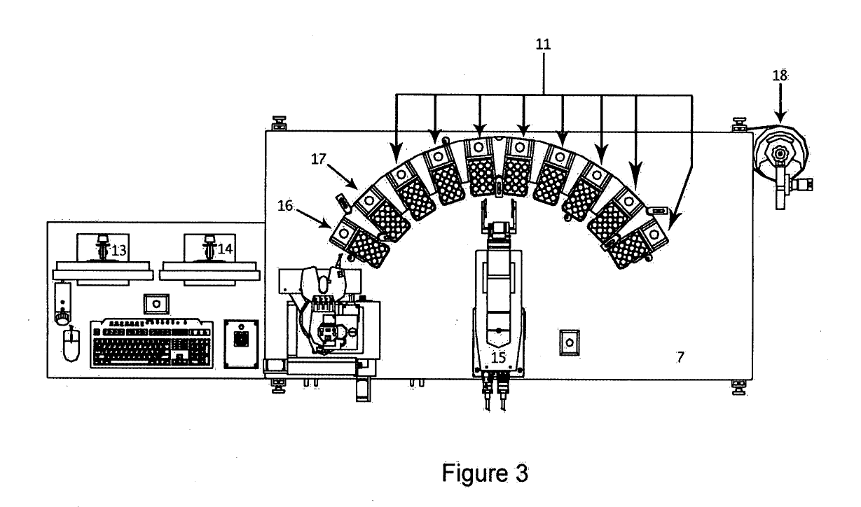

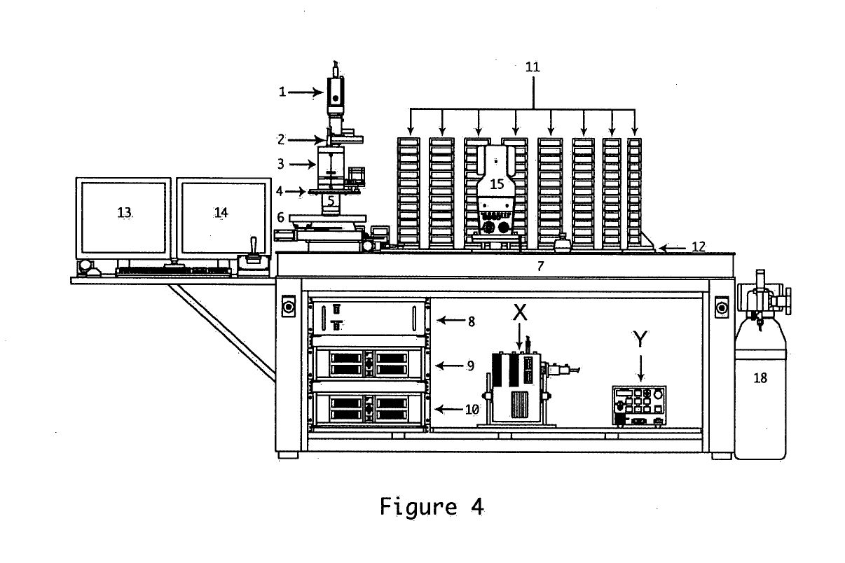

Referring now to FIGS. 1 through 4 with individual parts and components labeled and referred to parenthetically, a viewing and imaging apparatus is illustrated. The apparatus is used to handle plates containing biological specimens, automatically detects the biological specimens in the plates by observations made with a microscope assembly and automatically take images with a camera that can be further analyzed for various quantitative and qualitative attributes and characteristics.

1.) The Microscope Assembly

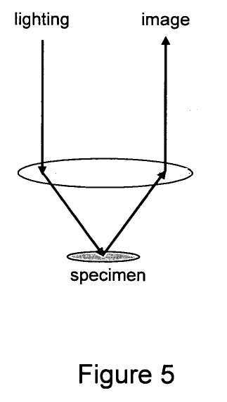

The microscope assembly comprises a commercially available stereoscopic dissecting microscope (3) in a unique configuration. One optical path through the microscope is used to deliver light to the specimen and the other path is used for observation and image capturing of the specimen. FIG. 5 illustrates that both lighting and observation pass through a common objective lens (5).

The microscope has two different magnification objective lenses (5) that are mounted on a custom-designed stepper motor-driven turret (4). The motor-driven turret is controlled by the system control computer (9) running software (described below) that allows the objectives to be changed automatically and for continual alignment accuracy with the optical paths. The commercially available objectives are changeable to give the desired range of magnification and are optically compatible with the two paths of the zoom system of the microscope.

The microscope is equipped with a motorized zoom system that will give 0.44× to 2333 optical magnification as required. This is accomplished by selectively using 0.63× and 2.0× objectives as required. The microscope used is a Leica model MZ16A with a Motor Focus Unit, Hand Control unit, and a custom designed objective lens changer.

2.) The Stage

Mounted below the microscope on a custom microscope base is the stage (6). The stage can be programmed to move to any position on the multiwell plate and will advance there by moving to the pre-selected point. The stage has two motorized drives “X” and “Y”, which can position the plate to a position accurately under the microscope to obtain a desired image.

Mounted on the stage is a custom insert plate that can accommodate a variety of multiwell plates and contain it in a secure position. Attached to this insert plate is a spring loaded plunger that locates and holds the plate in place. This plunger can be retracted by a solenoid for and during loading and unloading of the multiwell plate. An optical detector is located on the insert plate, which can verify the loading and unloading of a multiwell plate.

The stage is controlled by the system control computer (9) running software (described below) for programmed XY imaging stage movements. In order to load plates into the stage insert, the stage is programmed to move to the far right hand side on the “Y” axis and central with the “X”.

3.) The Robotic Arm, Controller for Plate-Handling, and Plate Storage racks and DE-lidding Station

The multiwell plates are stored on self-centering shelves that are mounted on a series of removable vertical towers (11). The robotic arm (15) requires that all shelves and vertical towers be accurately located for programming the robotic arm for delivery and retrieval. To accomplish this all shelves are accurately positioned on the towers and the towers are attached to sub-plates (12) that are accurately positioned angularly around the center axis of the robotic arm. The towers are readily detached from the sub-plates of the apparatus for loading, unloading and cleaning.

Two additional towers known as delidding/lidding stations (16, 17) and consisting of two shelves are also mounted on tower sub-plates next to the towers and in a radial manner from the center axis of the robotic arm. The delidding/lidding stations allow the robotic arm to remove the lids from the multiwell plate before inspection and replace the lids on the multiwell plate before returning the plate to the tower shelves.

The programmable robotic arm (15) with positioning software is commercially available. It is programmed to suit the present application. The robotic arm is a Mitsubitshi Model 2AJHV Robot with a RV-A Motorized Hand Set.

Positioning of the robotic arm (15) and the towers (11) has been optimized to maximize on the number of plates stored. A special fixture has been designed to align each tower's sub-plate with the robotic arm, ensuring accurate radial location of the towers.

4.) The Lighting and Imaging Capturing Subsystems

The preferred configuration of the present invention uses a broad-band illumination source, such as a halogen lamp or mercury-xenon arc lamp. The excitation illumination for the microscope enters the microscope via a custom housing from a liquid filled optic light guide and is transmitted to the objective through the zoom lenses. The image is transmitted through the chosen objective (5), back up through the other zoom path of the microscope. The image passes through a selectable emission filter that is mounted in a commercially available programmable filter wheel system (2). The images are captured by a commercial light sensitive cooled digital camera (1) and stored in the Data Storage subsystem (10). The filter wheels are Sutter Instruments model # LB10-2 Filter Wheel+Shutter and a LB10-W Additional Filter Wheel.

The filter wheel (2), camera (1) and light guide are mounted on the microscope by a custom designed fixture with built-in adjustable focusing lens to optimize the lighting and imaging.

The filter wheel (2) can hold 10 one inch diameter interference and/or neutral density filters. The filter wheel position can be rapidly changed under computer direction, giving the ability to conduct procedures which require more than one excitation wavelength.

The microscope is mounted on an automatic focusing device that can rapidly obtain focus of the specimen for any magnification. In adjusting the zoom magnification to view the specimen the lighting is proportionally concentrated on the viewing area.

5.) The Vibration Isolation Table

The microscope assembly (1-5), stage (6), robotic arm (15) and microplate storage towers (11, 12, 16 and 17) are mounted on the top surface of a commercially available optical table which is vibration isolated (7). This isolates the microscope from external vibrations, which can interfere with imaging at higher magnifications. The top surface has a series of tapped holes accurately located on one inch centers, which are used to attach the microscope base, the robotic arm base and the tower subplate (12). The Optical Table is a Kinetic Systems 9100 series table.

Under the table surface, there is an electronic panel rack to mount the two computers and the power supply/interface control box. A platform holds the fluorescent light source, robotic arm controller and the power and signal distribution system.

6.) Gas Delivery System

CO₂ can temporarily anesthetize or immobilize nematodes and other model organisms (e.g., Drosophila), which allows images of specimens to be taken at high magnifications that would otherwise be blurred. A custom delivery system has been designed to direct a blanket of gas on the well of the microplate being examined through a series of annular holes.

The delivery of gas is controlled by the system control computer (9) through activation or inactivation of a solenoid valve. Gas is delivered from a high pressure storage tank (18) through pressure regulators. It has been found that creating an atmosphere of CO2 gas in the microplate well, which is being examined, causes the nematodes and other specimens to be immobilized. When the specimens are immobilized, the optical and camera system can obtain better pictures and positional registration information.

To create this localized condition it was necessary to develop a delivery device which was positioned between the microscope objective and the microplate well. This required the delivery device to have a very thin cross-sectional thickness to function within the confines of the focal distance between the microscope objective and the specimen on the surface of the well. The device could not interfere with the imaging of the specimen and it should deliver an even coverage of gas.

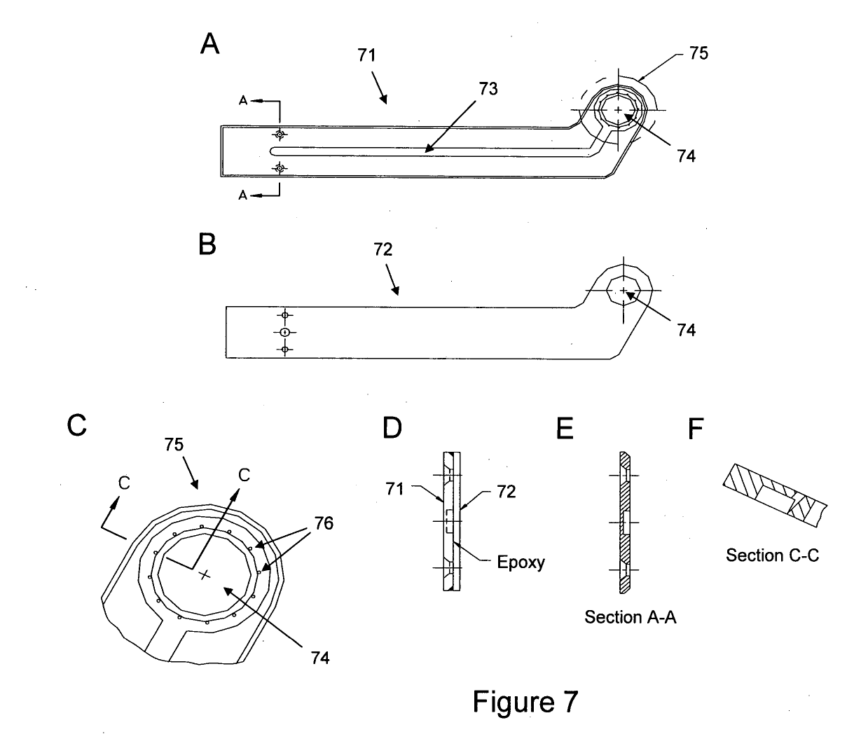

In one embodiment of the gas delivery system is shown in FIG. 7. The gas delivery system is constructed of two thin plates of stainless steel. One of which is about 0.094 inches thick (FIG. 7A, 71) and the other is about 0.031 inches thick (FIG. 7B, 72). In some embodiments, these sections can be thinner. A channel is milled longitudinally in the thicker plate (73) which is used to deliver the gas to an annular groove which surrounds the microscope objective observation hole (74) (expanded view shown in FIG. 7C, 75). In the inside corner of the groove are a number of equally spaced small holes (76) of about 0.031 inches in diameter which guide the gas into the well of a microplate (not shown). The thin plate (72) is bonded to the top of the thicker plate with the delivery grooves (71) to form a laminated sealed assembly for delivering the pressurized gas (though inlet 77) (see FIG. 7D). FIGS. 7E and 7F show cross sectional views through plane A of FIG. 7A and through plane C of FIG. 7C, respectively.

The gas (e.g., CO₂) is transferred to the laminated assembly through an attached stainless steel block (not shown), from a supply tube and barb fitting. The block is sealed to the laminated assembly by an interfacing o-ring.

The gas supply comes from a high pressure tank with an adjustable pressure regulator and an adjustable flow restrictor to control the amount of gas delivered to a microplate well. The gas can be turned off and on as needed by an inline solenoid valve, which is controlled by the system programming.

Software

1.) Computer Control

The software that is controlled by the computer is divided into two aspects. The first aspect relates to a Plate Management Application for plate handling and plate information management. The second aspect relates to an Imaging Application for capturing and viewing images, image analysis and image management. All software control, imaging, and analysis functions are resident within the computer.

2.) Plate Management Application Features

This aspect of the software relates to movement and handling of multiwell plates. At its core, the Plate Management Application (PMA) comprises a graphical user interface depicting all multiwell plate positions including storage positions, de-lid station, re-lid station and XY imaging stage.

In certain embodiments, the PMA may also contain any or all of the following features:

1. Supports barcode scanner mounted on robot arm which includes the ability to:
a. Read barcode labels applied to the front of multiwell plates
b. Support and maintain barcode identification and information format including experiment name and plate number
c. Control of automatic robot assisted scanning of all or selected plate storage or station positions
d. Creation and maintenance of a scanned plate database
e. Read what protocol to be run

2. Manages transport of plates and lids by the robotic arm. Specifically:
a. transport of plates to the de-lid station and removal of the lid.
b. transport of plates from the de-lid station to the XY imaging stage
c. movement of the lid of the plate on the imaging XY imaging stage to the re-lid station
d. transport of next plate to be processed to the de-lid station in a parallel manner, i.e., while the previous plate is being imaged on the XY stage
e. transport of processed plate from the imaging XY imaging stage to the de-lid station, replacement of the lid, and transport back to the original storage position

3. Communicates with the Imaging application to coordinate plate delivery and removal from the XY Imaging Stage.

4. Passes plate identification to the Imaging Application.

5. Designed to prevent collision of the robot arm with any system object.

6. Allows for addition of a plate or plates and its identification or definition to the database through the graphical user interface.

7. Designed for unattended, automated operation.

8. Compiles a list of experiment names from the plate database and passes the list to the Imaging Application.

Once the PMA has placed a multiwell plate on the XY imaging stage, the Imaging Application executes an experimental analysis protocol based upon the information it receives from the PMA.

In certain embodiments, the Imaging Application feature may contain any or all of the following capabilities:

1. Execute multiple experiment analysis protocols in any run of plates

2. Receive a list of experiment names from the Plate Management Application

3. Check list of experiment names against experiment procedures defined in the Imaging Application's procedure database

4. Generate a warning to user upon receipt of experiment names with undefined procedures

5. Receive identification of individual plates from the Plate Management Application at time of plate delivery to the XY imaging stage

6. Execute appropriate experiment analysis protocol for each plate as defined by the experiment name in the plate identification

7. Execute an experiment analysis protocol comprised of a sequence of steps that may include objective lens selection, zoom magnification selection, emission and excitation filter selection, light source selection, and image analysis macro routines.

8. Execute multiple types of image processing macros at a defined field of view, which include but are not limited to:
a. Count—counts and sorts nematode objects by size in a brighffield, full well field of view
b. Search—Identifies a user definable number of candidate nematode objects for imaging at high magnification
c. Re-center—Centers the highest scoring nematode or object in the field of view for viewing at high magnification or with other techniques
d. None—No image processing macro is executed for the field of view

9. Move objective lenses via the turret with collision avoidance logic to ensure that objective lenses are not damaged

10. Scan wells of a multiwell plate in a definable pattern for highest movement efficiency

11. Automatically calibrate each field of view, as defined by an encoded zoom position and an encoded objective lens combination, in microns per pixel and saves that data with the image.

12. Provide parfocality compensation for each defined field of view so as to parfocalize lens of different focal distances

13. Automatically center an object of interest via programmed XY imaging stage movements by virtue of a score from an image analysis algorithm

14. Display experiment analysis protocols in an icon based graphical representation

15. Execute user configurable auto-focus routines to find the optimal focal plane

16. Control the imaging system to operate in a fluorescence or brightfield illumination mode

17. Control the dispensing of gas through a microplate applicator

18. Acquires images, names image files, and stores images in a temporary working directory

19. Performs post-processing on acquired images residing in the working directory

20. Archives images in the temporary working directory to a user definable directory

The invention has been described herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

### Exemplary Applications

The imaging systems and methods of the invention find use in a variety of settings with a variety of different biological specimens. The systems and methods of the invention also allow for following a biological specimen over any desired time interval, e.g., for a period of more than 2 hours, 5 hours, 12 hours, 24 hours, 2 days, 4 days, 6, days, 7 days, weeks and/or up to the life of a biological specimen of interest in tissue culture. Imaging of the biological specimen may occur at regular time intervals corresponding to those above or otherwise. The following are non-limiting examples of such, and further highlight certain advantages and features of the invention.

1). Immobilization of the Biological Specimen of Interest.

The present invention provides means for the temporary immobilization of the biological specimen prior to viewing and imaging. In one embodiment, the immobilization apparatus dispenses a layer of CO₂ gas onto the substrate on which the biological specimen is housed in an optimized amount such that immobilization is reversible. Example multicellular organisms for which this embodiment of the invention would work include C. elegans and D. melanogaster. In another embodiment, the immobilization apparatus can deliver an anesthetizing fluid for the purpose of immobilizing the subject biological specimen prior to imaging.

2.) High Throughput Screening Methods.

The systems and methods of the invention find particular application in high throughput screening assays. Examples of such assays, without limitation, include identification of agents that elicit a desired response in a biological specimen (e.g., modulation of gross morphology, motility, cellular composition, fecundity, and specific cellular responses including modulation of activity of signal transduction pathways, modulation of transcriptional activity, and the like) as well as analysis of nucleic acids of previously unknown or uncharacterized function (e.g., by introduction of a coding sequence of interest into a target biological specimen for expression of the encoded protein in the biological specimen or a subset of cells thereof followed by analysis).

In general, the systems and methods of the invention allow for analysis of the effect of agents in biological specimens over desired time intervals.

3.) Detection of Multiple Variables in Screening Assays and Imaging Over Time.

The imaging systems and methods of the invention can be used to obtain data for multiple variables in a single sample. For example, one or more biologic variables can be detected using varying optical illumination and detection settings using the system of the invention. For example, a biological specimen can, in a single imaging session, be imaged using bright-field settings and fluorescence-emission settings (e.g., to detect expression of GFP in cells of the biological specimen).

The imaging systems of the invention can be used to analyze changes in a biological specimen over time, e.g., caused by contacting a biological specimen with an agent (e.g., increasing concentrations of an agent, adding additional agents, etc.), changing an environmental condition (e.g., modulation of temperature, osmolarity, etc.). For example, imaging of a biological specimen or a cell subset thereof for one or more optical characteristics may be assayed over time or multiple different time intervals. In general, the optical characteristics can be any detectable biological activity, cell component or cell product, particularly those which can be measured with sufficient accuracy and, preferably, can be detected in a manner compatible with a high throughput assay of the invention. Exemplary optical characteristics include, gene transcription or gene product expression levels (e.g., by detection of a reporter gene or fusion gene (e.g., GFP fusion protein)); cell differentiation (e.g., by detection of formation of cellular structures (e.g., vulval precursor cell formation in C. elegans)), the presence or absence of cell differentiation antigens, and the like); or transfection status (i.e., presence or absence of a recombinant polynucleotide for analysis in a target cell); and the like.

Where more than one optical characteristic is to be assessed, distinguishable markers can be used to detect the different variables. For example, where the screening assay involves assessing the effect of a gene product encoded in a polynucleotide, one marker can be used to identify cells expressing the construct of interest (e.g., by virtue of a detectable marker that is co-experessed with the gene of interest), while a second marker can be used to detect the expression of another gene product (e.g, as in a detectable marker provided by a fusion protein produced from the gene product encoded by the polynucleotide). A third detectable marker can be used to assess the effect of the gene product upon the target biological specimen (e.g., to assess viability, expression of a reporter gene under control of a promoter suspected of being regulated by a gene product of the candidate polynucleotide or by a factor regulated by a gene product of the candidate polynucleotide, and the like). In addition, information about cell morphology changes can also be obtained through phase contrast images, which images can be aligned with and compared with, for example, fluorescent images on an individual biological specimen.

Various methods can be utilized for quantifying the presence of the selected markers. Fluorescent moieties are readily available for labeling virtually any biomolecule, structure, or cell type. Immunofluorescent moieties can be directed to bind not only to specific proteins but also specific conformations, cleavage products, or site modifications like phosphorylation. Individual peptides and proteins can be engineered to autofluoresce, e.g. by expressing them as green fluorescent protein chimeras inside cells (for a review see Jones et al. (1999) Trends Biotechnol 17(12):477-81).

Fluorescence technologies have matured to the point where an abundance of useful dyes are now commercially available. These are available from many sources, including Sigma Chemical Company (St. Louis Mo.) and Molecular Probes (Handbook of Fluorescent Probes and Research Chemicals, Seventh Edition, Molecular Probes, Eugene Oreg.). Other fluorescent sensors have been designed to report on biological activities or environmental changes, e.g. pH, calcium concentration, electrical potential, proximity to other probes, etc. Methods of interest include calcium flux, nucleotide incorporation, quantitative PAGE (proteomics), etc.

Multiple fluorescent labels can be used in the same assay, and biological specimens individually detected qualitatively or quantitatively, permitting detection and/or measurement of multiple responses simultaneously. Many quantitative techniques have been developed to harness the unique properties of fluorescence including: direct fluorescence measurements, fluorescence resonance energy transfer (FRET), fluorescence polarization or anisotropy (FP), time resolved fluorescence (TRF), fluorescence lifetime measurements (FLM), fluorescence correlation spectroscopy (FCS), and fluorescence photobleaching recovery (FPR) (Handbook of Fluorescent Probes and Research Chemicals, Seventh Edition, Molecular Probes, Eugene Oreg.). Of particular interest are those labeling techniques that are compatible with living organisms/cells and, where desired, with use over a desired time interval (e.g., comparison of images taken over a period of hours or of days).

4.) Candidate Agents.

The term “agent” as used herein describes any molecule of interest that can be contacted with a living biological specimen to impart an effect upon it. Because of the high throughput abilities of the invention, a plurality of assay mixtures can be performed in parallel in different wells (e.g., in different wells of a multi-well plate) with different agent concentrations in order to examine the concentration-dependency of the observed effects. Typically, one of these concentrations serves as a negative control, i.e., at zero concentration or below the level of detection.

Candidate agents as used herein is meant to encompass numerous chemical classes, including, but not limited to, nucleic acids (e.g., DNA, RNA, antisense/RNAi polynucleotides, and the like), polypeptides (e.g., proteins, peptides, and the like) organic molecules (e.g., small organic compounds having a molecular weight of more than 50 and less than about 2,500 daltons), chemical mutagens (e.g., EMS and ENU), irradiation, ribozymes, and the like. Candidate agents can comprise functional groups necessary for structural interaction with proteins or nucleic acids, particularly hydrogen bonding, and typically include at least an amine, carbonyl, hydroxyl or carboxyl group, and sometimes at least two of the functional chemical groups. The candidate agents often comprise cyclical carbon or heterocyclic structures and/or aromatic or polyaromatic structures substituted with one or more of the above functional groups. As indicated above, candidate agents are also found among biomolecules including, but not limited to: polynucleotides, peptides, saccharides, fatty acids, steroids, purines, pyrimidines, derivatives, structural analogs or combinations thereof.

In some embodiments of the invention, random mutagenic agents are employed to induce mutation(s) in the biological specimen of interest followed by observation to screen for specific phenotypes of interest. In these assays, chemical mutagens or irradiation may be employed as the mutagenic agent.

Candidate agents can be obtained from a wide variety of sources including libraries of synthetic or natural compounds. For example, numerous means are available for random and directed synthesis of a wide variety of organic compounds and biomolecules, including expression of randomized oligonucleotides and oligopeptides. Alternatively, libraries of natural compounds in the form of bacterial, fungal, plant and animal extracts are available or readily produced. Additionally, natural or synthetically produced libraries and compounds are readily modified through conventional chemical, physical and biochemical means, and may be used to produce combinatorial libraries. Known pharmacological agents may be subjected to directed or random chemical modifications, such as acylation, alkylation, esterification, amidification, etc. to produce structural analogs.

5.) General Assay Methods.

Regardless of the goal of the screening assay, the assays involve contacting the agent and the biological specimen, which may include introducing the agent into the biological specimen, e.g., in the case of genetic agents, or simply adding the agent to the well containing the biological specimen (e.g., a chemical mutagen or member of a library of compounds) and detecting one or more variables. The change in biological specimen parameter readout in response to the agent is measured, desirably normalized, and the parameter evaluated by comparison to reference readouts. The reference readouts may include basal readouts in the presence and absence of the factors, readouts obtained with other agents, which may or may not include known inhibitors of known pathways, etc. Agents of interest for analysis include any biologically active molecule with the capability of modulating, directly or indirectly, the parameter of interest of a biological specimen of interest.

The agents are conveniently added to biological specimen in solution, or readily soluble form, to the medium of biological specimen in culture. The agents may be added in a flow-through system, as a stream, intermittent or continuous, or alternatively, adding a bolus of the compound, singly or incrementally, to an otherwise static solution. In an exemplary flow-through system, two fluids are used, where one is a physiologically neutral solution, and the other is the same solution with the test compound added. The first fluid is passed over the biological specimen, followed by the second. In a single solution method, a bolus of the test compound is added to the volume of culture substrate surrounding the biological specimen (or on which the biological specimen is grown). The overall concentrations of the components of the culture substrate should not change significantly with the addition of the bolus, or between the two solutions in a flow through method.

In some embodiments, agent formulations do not include additional components, such as preservatives, that may have a significant effect on the overall formulation. Thus agent formulations can consist essentially of an agent to be tested and a physiologically acceptable carrier, e.g. water, cell culture medium, etc. In other embodiments, other reagents may be included in the screening assays, such as those to provide for optimal binding of agents to a binding partner, to reduce non-specific or background interactions, and the like. Such reagents should be, of course, selected so as to be compatible with screening of living biological specimens.

As noted above, a plurality of assays may be run in parallel with different agent concentrations to obtain a differential response to the various concentrations. As known in the art, determining the effective concentration of an agent typically uses a range of concentrations resulting from 1: 10, or other log scale, dilutions. The concentrations may be further refined with a second series of dilutions, if necessary. Typically, one of these concentrations serves as a negative control, i.e. at zero concentration or below the level of detection of the agent or at or below the concentration of agent that does not give a detectable change in the phenotype.

6.) Functional Genetic Assays.

In one embodiment, the imaging systems and methods of the invention are used to provide high throughput functional genetics screening assays. Such assays, in general, involve examining biological specimens that have been genetically altered (e.g., by stable or transient introduction of a recombinant gene, or by antisense or RNAi technology) to assess whether the genetic alteration results in a gain or loss in a biological function in the target biological specimen. In addition to identification of agents that may be useful as drugs (e.g., as in gene therapy or antisense therapy), such assays are useful for, for example, identification of a gene of interest by virtue of the gain or loss of function, as well as analysis of genes of unknown function.

Methods for generating genetically modified cells are known in the art, see for example “Current Protocols in Molecular Biology”, Ausubel et al., eds, John Wiley & Sons, New York, N.Y., 2000. The functional genetics assays in some embodiments can also serve as drug screening assays, where the candidate agent can be a polynucleotide, which polynucleotide can, for example, encode a gene product of interest (e.g., a peptide, protein, or an RNAi agent). Exemplary “genetic agents” are described in more detail below. The genetic alteration may be a knock-out, usually where homologous recombination results in a deletion that reduction (e.g., to undetectable levels) of expression of a targeted gene; or a knock-in, where a genetic sequence not normally present in the biological specimen is stably introduced.

A variety of methods may be used in the present invention to achieve a knock-out, including site-specific recombination, expression of anti-sense, RNAi or dominant negative mutants, and the like. Knockouts have a partial or complete loss of function in one or both alleles of the endogenous gene in the case of gene targeting. Preferably expression of the targeted gene product is undetectable or insignificant in the cells being analyzed. This may be achieved by introduction of a disruption of the coding sequence, e.g. insertion of one or more stop codons, insertion of a DNA fragment, etc., deletion of coding sequence, substitution of stop codons for coding sequence, etc. In some cases the introduced sequences are ultimately deleted from the genome, leaving a net change to the native sequence.

In general, functional genetics assays involve screening for the effect of addition or loss of function of a gene product through manipulation of a cell by introduction of a nucleic acid (e.g., by expression of a recombinant protein, RNAi-mediated inhibition of expression, and the like). Such agents are referred to herein as “genetic agents” for convenience and without limitation. The introduction of a genetic agent generally results in an alteration of the total nucleic acid composition of the cell. Genetic agents such as DNA can result in an experimentally introduced change in the genome of a cell, generally through the integration of the sequence into a chromosome. Genetic changes can also be transient, where the exogenous sequence is not integrated but is maintained as an episomal agent. Genetic agents, such as RNAi polynucleotides, can also affect the expression of proteins without changing the cell's genotype, by interfering with the translation of mRNA. In general, the effect of a genetic agent is to increase or decrease expression of one or more gene products in the biological specimen or cell subset(s) thereof.

Introduction of an expression vector encoding a polypeptide can be used to express the encoded product in cells lacking the sequence, or to over-express the product (e.g., to provide for an expression level greater than that associated with expression of the endogenous gene alone). Various promoters can be used that are constitutive or inducible. These coding sequences may include full-length cDNA or genomic clones, fragments derived therefrom, or chimeras that combine a naturally occurring sequence with functional or structural domains of other coding sequences. Alternatively, the introduced genetic agent may encode an RNAi sequence; be an RNAi oligonucleotide; encode a dominant negative mutation, or dominant or constitutively active mutations of native sequences; altered regulatory sequences, etc.

In addition to genetic agents having sequences derived from the host cell species, other genetic agents of interest can include, for example, genetic agents having sequences obtained from pathogens, for example coding regions of viral, bacterial and protozoan genes, particularly where the genes affect the function of human or other host cells. Sequences from other species may also be introduced, where there may or may not be a corresponding homologous sequence.

A large number of public resources are available as a source of genetic sequences, e.g., for human, other mammalian, and human pathogen sequences. A substantial portion of the human genome is sequenced, and can be accessed through public databases such as Genbank. Resources include the uni-gene set, as well as genomic sequences. For example, see Dunham et al. (1999) Nature: 402 489-495; or Deloukas et al. (1998) Science 282: 744-746. cDNA clones corresponding to many human gene sequences are available from the IMAGE consortium. The international IMAGE Consortium laboratories develop and array cDNA clones for worldwide use. The clones are commercially available, for example from Genome Systems, Inc., St. Louis, Mo. Methods for cloning sequences by PCR based on DNA sequence information are also known in the art.

A variety of host-expression vector systems may be utilized to express a genetic coding sequence. Expression constructs may contain promoters derived from the genome of mammalian cells, e.g., metallothionein promoter, elongation factor promoter, actin promoter, etc., from mammalian viruses, e.g., the adenovirus late promoter; the vaccinia virus 7.5K promoter, SV40 late promoter, cytomegalovirus, etc. In mammalian host cells, a number of viral-based expression systems may be utilized, e.g., retrovirus, lentivirus, adenovirus, herpesvirus, and the like.

7.) Kits.

Kits for use in connection with the subject invention may also be provided. Such kits preferably include at least a computer readable medium including instructions and programming embodying or adapted to direct the functionality as discussed above. The instructions may include software installation or setup directions to program an otherwise ordinary microscope or cell scanner so as to function as described. The instructions may include directions for directing the microscope to perform as desired. Preferably, the instructions include both types of information.

Providing the software and instructions as a kit may serve a number of purposes. The combination may be packaged and purchased as a means of upgrading an existing microscope. The full program or some portion of it (preferably at least such code as defining the subject methodology—alone or in combination with the code already available) may be provided as an upgrade patch. Alternately, the combination may be provided in connection with a new microscope in which the software is preloaded on the same. In which case, the instructions may serve as a reference manual (or a part thereof and the computer readable medium as a backup copy to the preloaded utility.

The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging), etc. In other embodiments, the instructions are present as an electronic storage data file present on a suitable computer readable storage medium, e.g., CD-ROM, diskette, etc., including the same medium on which the program is presented.

In yet other embodiments, the instructions are not themselves present in the kit, but means for obtaining the instructions from a remote source, e.g. via the Internet, are provided. An example of this embodiment is a kit that includes a web address where the instructions can be viewed and/or from which the instructions can be downloaded. Conversely, means may be provided for obtaining the subject programming from a remote source, such as by providing a web address. Still further, the kit may be one in which both the instructions and software are obtained or downloaded from a remote source, as in the Internet or world wide web. Of course, some form of access security or identification protocol may be used to limit access to those entitled to use the subject invention. As with the instructions, the means for obtaining the instructions and/or programming is generally recorded on a suitable recording medium.

### EXPERIMENTAL

The following examples are offered by way of illustration and not by way of limitation.

### EXAMPLE 1

Acquire brighffield and fluorescent images of individual objects within a well of multiwell plate. Each well of a 12-well plate is processed with the following steps:

1. In order to arrest nematode locomotion, the HIDI control system applies carbon dioxide gas to the well under operation using a proprietary gas applicator

2. A brightfield full well image of a well is acquired using a software based auto-focus algorithm

3. The full well image is analyzed to identify individual nematodes.

4. Five centrally located full sized worms are chosen for observation

5. The system magnification is increased so that an acquired image fits one full sized nematode

6. The XY imaging stage is moved until the 1^{st} of the five chosen nematodes is centered in the field of view

7. A sequence of images are acquired using brightfield, YFP and RFP filter sets

8. The XY imaging stage is moved to center the 2^{nd} of the five chosen nematodes in the field of view

9. Images are acquired of all chosen nematodes using the same sequence as the 1^{st} chosen nematode

10. The experiment sequence is user configurable to include as many fluorescence filter sets as reside in the HIDI system and in any order

11. The number of nematodes to image is user selectable

12. The imaging magnification is user selectable

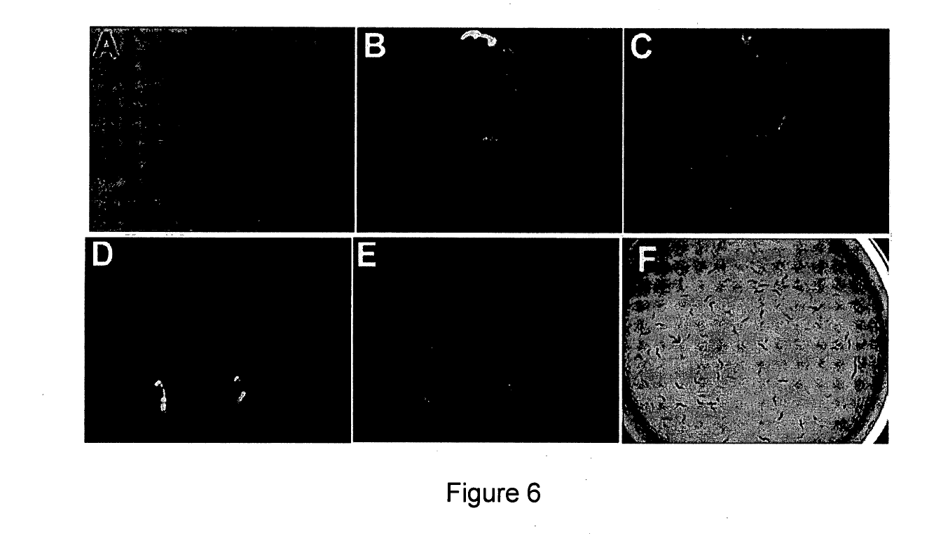

FIG. 6 shows a panel of images taken of C. elegans. Note that tissues and organelles within the object are clearly visible in images A through E. This unique feature offers high resolution imaging not only of an entire object of tissue and cellular granularity, which is not available with any other imaging system. Image F is a low magnification view of a well used for counting and to assess the health of the well population.

### EXAMPLE 2

Imaging a full well, and counting and analyzing objects in the well. Each well of a 12-well plate is processed with the following protocol:

1. A brightfield full well image of a well is acquired using a software based auto-focus algorithm

2. The full well image is processed within a user definable area of interest

3. The area of interest is analyzed to identify individual nematodes.

4. The identified nematodes are measured in size and counted.

5. Counts are parsed into user configurable bins according to nematode size.

6. The full well image is stored on disk.

7. A count results file is generated containing a table of all well counts for the experiment run.

What is claimed is:

1. A method for imaging one or more optical characteristics of a biological specimen, the method comprising:
a) placing a plate containing a biological specimen onto the observation stage under the objective of a microscope with a long working distance using a robotic plate handling system;
b) locating said biological specimen in said plate;
c) focusing said microscope to observe said one or more optical characteristics of said biological specimen; and
d) collecting, analyzing, and storing image data of said observed biological specimen;
wherein each of said steps is automated using integrated hardware and software components.

2. The method according to claim 1, wherein said microscope is an autofocusing dissecting microscope comprising at least one objective mounted on a motorized movement element.

3. The method according to claim 1, wherein said optical characteristics imaged are selected from the group consisting of fluorescent emissions, luminescent emissions, chemiluminescent emissions, and reflected light.

4. The method according to claim 1, wherein said biological specimen is a multi-cellular organism.

5. The method according to claim 4, wherein said multicellular organism is chosen from the group comprising Caenorhabditis, Drosophila, Danio, and Xenopus or the phylum Chordata.

6. The method according to claim 5, wherein said multicellular organism is alive.

7. The method according to claim 6, wherein said live multicellular organism is immobilized by exposing said organism to an immobilizing compound prior to visualization using an automated immobilization system.

8. The method according to claim 7, wherein said immobilization is reversible.

9. The method according to claim 7, wherein said immobilization is not reversible.

10. The method according to claim 7, wherein said immobilizing compound is CO₂ gas.

11. The method according to claim 1, wherein said biological specimen is grown on or in a semi-solid substrate of greater than 5 mm in thickness.

12. The method according to claim 1, wherein said biological specimen is an embryoid body.

13. The method according to claim 1, wherein said biological specimen is a plant.

14. The method according to claim 1, wherein said biological specimen is contacted with a candidate agent.

15. The method of claim 14, wherein said contacting is after obtaining a first image and prior to obtaining a second image of said biological specimen.

16. The method according to claim 1, wherein said plate contains multiple independent wells.

17. The method according to claim 1, wherein said plate is housed in a handling unit that contains a plurality of said plates.

18. The method according to claim 17, wherein each plate of said plurality is identifiable using a bar code tagging and scanning system.

19. The method according to claim 1, wherein said locating step is achieved using a motor-driven x-y stage on said microscope which automatically aligns said plates and wells thereof with respect to the position of the objectives of said microscope.

20. The method according to claim 1, wherein said imaging is done using a CCD camera for real-time visualization and capturing of images viewed through the microscope either of individual organisms or of the entire well or plate of organisms.

21. The method according to claim 1, wherein said data is collected, analyzed and stored using software for viewing archived or real time images obtained.

22. An automated microscopy apparatus for imaging at least one optical characteristic of a biological specimen in a plate comprising:
(a) an autofocusing microscope with a long working distance that observes said biological specimen from above;
(b) a robotic plate handling system;
(c) a CCD camera for real-time visualization and capturing of images viewed through said dissecting microscope; and
(d) software and hardware to control said microscopy system and store and analyze the images obtained therefrom.

23. The microscopy apparatus according to claim 22, wherein said apparatus further comprises a motor-driven x-y stage positioned under the objective of said microscope which holds said plate containing said biological specimen.

24. The microscopy apparatus according to claim 22, wherein said apparatus comprises at least one objective mounted on a motorized movement element.

25. The microscopy apparatus according to claim 22, wherein said apparatus comprises multiple light sources and optical filters for direct bright field illumination, indirect lighting and fluorescent viewing and imaging of said biological specimen.

26. The microscopy apparatus according to claim 22, further comprising software for processing image data.

27. The microscopy apparatus according to claim 22, further comprising an automated immobilizing compound injection system.

28. The immobilizing compound injection system according to claim 27, wherein said immobilizing compound is CO₂ gas.

29. The microscopy apparatus according to claim 22, wherein said robotic plate handling system holds multiple plates.

30. The robotic plate handling system according to claim 29, wherein said apparatus comprises a bar code reader.
